(19) United States
(12) Patent Application Publication
(10) Pub. No.: US 2010/0088770 A1
(43) Pub. Date: Apr. 8, 2010

(54) DEVICE AND METHOD FOR DISJOINTED COMPUTING

(76) Inventors: Raz Yerushalmi, Kfar Varburg (IL); Roie Yerushalmi, Kfar Varburg (IL); Gustav Poola, San Jose, CA (US); Barak Engel, El Sobrante, CA (US); Idan A. Levin, Emeryville, CA (US)

Correspondence Address: Pearl Cohen Zedek Latzer, LLP, 1500 Broadway, 12th Floor, New York, NY, 10036, US

(21) Appl. No.: 12/247,328

(22) Filed: Oct. 8, 2008

(51) Int. Cl. G06F 21/24

(52) U.S. Cl. 726/26

(57) ABSTRACT

A method and system are described for processing an extended information element, the extended information element being composed of a word component and a stamp component, by a computing system that can transfer the extended information element but cannot manipulate the stamp component of the extended information element. The method includes: providing a stamp processing system for manipulating the stamp component, processing a value of the stamp component by the stamp processing system, and controlling an operation on the word component based on the value of the stamp component.

### FIELD OF THE INVENTION

The present invention relates to computing. More particularly, the present invention relates to a device and method for disjointed computing.

### BACKGROUND OF THE INVENTION

A typical computing system includes various components such as memory and data storage units, processing units, input devices, and output devices. Commonly, such components are capable of sharing information and resources. Typically, access to the shared information and resources is controlled by an operating system. The operating system software usually shares those same system resources according to pre-defined rules.

Computing systems are subject to unwanted, unauthorized, or malicious access to, and usage of, system resources. Such unwanted access and usage is made possible by the operational coupling among the system components. Such unwanted access and usage may include threats commonly referred to as malware, including viruses, Trojan horses, and backdoors, as well as unintentional vulnerabilities resulting from, for example, design faults in software or hardware, or administration errors. Various approaches have been developed and are currently in use in order to protect systems and information from a variety of threats. Such approaches include: anti-virus software, spam filters, firewalls, PIN codes, operating system security, encryption, and other methods.

However, most of currently known approaches for information security are based on countermeasures to previously identified threats. These approaches are limited in providing systematic, cohesive protection for information security at the fundamental levels of the computing system and the information unit.

This situation may be considered a direct result of the typical architecture of the computing platforms currently in use. These platforms are designed to provide reliable access to data. However, current platform designs offer little or no data security at the level of fundamental hardware architecture design, and rely heavily on software and add-on hardware technologies. This may be illustrated by the concept of the “administrator”, or “root user,” in operating systems for current computing platforms. This privileged user may have extensive access to system resources and data and may bypass substantial aspects of security and other controls implemented in the system. This approach raises some serious concerns. Since gaining administrative access to a system enables full or privileged control, attack vectors may attempt to enable such access to a target system. Such vectors often rely on gaining unprivileged access to the system (for example, by compromising a guest or user account), and then use buffer overflows, race conditions, or other techniques to promote the access privilege to the administrator level. Because even well-implemented and protected systems may be vulnerable to an administrator user type, gaining administrative privileges is often an approach used in attacks that target data. Furthermore, administrative access provides an attacker with another benefit, namely the capability of eliminating the possibility of tracing the origin of the attack. Since administrators can usually override all system security mechanisms, they can control auditing mechanisms and thus render them unreliable.

It is an object of the present invention to provide comprehensive security architecture for computing systems.

### SUMMARY OF THE INVENTION

There is thus provided, in accordance with some embodiments of the present invention, a method for processing an extended information element, the extended information element composed of a word component and a stamp component, by a computing system that can transfer the extended information element, but cannot manipulate the stamp component of the extended information element. The method comprises: providing a stamp processing system for manipulating the stamp component, processing a value of the stamp component by the stamp processing system, and controlling an operation on the word component based on the value of the stamp component.

Furthermore, in accordance with some embodiments of the present invention, the method further comprises generating the stamp component.

Furthermore, in accordance with some embodiments of the present invention, the method comprises assigning the value to the stamp component.

Furthermore, in accordance with some embodiments of the present invention, the value of the stamp indicates a characteristic of the word component.

Furthermore, in accordance with some embodiments of the present invention, the characteristic of the word is selected from the group of characteristics consisting of: type, source of the word component, connection port through which the word component was received, time, security profile, access rights, read-only, hidden and human defined value.

Furthermore, in accordance with some embodiments of the present invention, the operation is performed by the computing system.

Furthermore, in accordance with some embodiments of the present invention, the operation on the word component comprises enabling or disabling the processing of the word component.

Furthermore, in accordance with some embodiments of the present invention, the operation on the word component comprises encryption or decryption.

Furthermore, in accordance with some embodiments of the present invention, the word component is a 32-bit word and the stamp component includes at least one additional bit.

Furthermore, in accordance with some embodiments of the present invention, the extended information element is selected from a group of information elements ranging from 9 to 128 bit information elements.

Furthermore, in accordance with some embodiments of the present invention, the step of controlling the operation on the word component based on the value of the stamp component is executed by the stamp processing system.

Furthermore, in accordance with some embodiments of the present invention, there is provided a system for processing an extended information element, the extended information element composed of a word component and a stamp component, by a computing system that can transfer the extended information element but cannot manipulate the stamp component of the extended information element. The system comprises a stamp processing system for manipulating the stamp component, adapted to process a value of the stamp component, for controlling an operation on the word component based on the value of the stamp component.

Furthermore, in accordance with some embodiments of the present invention, the stamp processing system is adapted to generate the stamp component.

Furthermore, in accordance with some embodiments of the present invention, the stamp processing system is adapted to assign the value to the stamp component.

Furthermore, in accordance with some embodiments of the present invention, the value of the stamp indicates a characteristic of the word component.

Furthermore, in accordance with some embodiments of the present invention, the characteristic of the word is selected from the group of characteristics consisting of: type, source of the word component, connection port through which the word component was received, time, security profile, access rights, read-only, hidden and human defined value.

Furthermore, in accordance with some embodiments of the present invention, the operation is performed by the computing system.

Furthermore, in accordance with some embodiments of the present invention, the operation on the word component comprises enabling or disabling the processing of the word component.

Furthermore, in accordance with some embodiments of the present invention, the operation on the word component comprises encryption or decryption.

Furthermore, in accordance with some embodiments of the present invention, the word component is a 32-bit word and the stamp component includes at least one additional bit.

Furthermore, in accordance with some embodiments of the present invention, the extended information element is selected from a group of information elements ranging from 9 to 128 bit information elements.

Furthermore, in accordance with some embodiments of the present invention, the stamp processing system is adapted to control the operation on the word component based on the value of the stamp component.

Furthermore, in accordance with some embodiments of the present invention, the stamp processing system and the computing system are integrated.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic diagram of a disjointed computing system operating on an extended information element, in accordance with embodiments of the present invention.

FIG. 2 is a schematic illustration of an extended information element with a word component and a stamp component, in accordance with embodiments of the present invention.

FIG. 3 is a block diagram of a secure transaction record system in accordance with embodiments of the present invention.

FIG. 4 is a block diagram of continuous distributed data management in accordance with embodiments of the present invention.

### DETAILED DESCRIPTION OF EMBODIMENTS

A disjointed computing system, in accordance with embodiments of the present invention, includes at least two systems which may be referred to as disjointed subsystems.

A disjointed subsystem is defined here as a system of components so configured that information contained within one of the components, may, under certain conditions, be transferred to or from, processed by, altered by, or used by one or more of the other components in the system of components. Within a single disjointed subsystem, components may be operationally coupled in a unidirectional, bi-directional, or multi-directional manner.

The basic data unit in a disjointed computing system is an extended information element, also referred to as a basic electronic information unit (BEIU). A BEIU includes two or more data components. In general, the number of data components will equal the number of disjointed subsystems included in the disjointed computing system. In general, each disjointed subsystem operates on a single data component of a BEIU and cannot operate on any other data component. However, the disjointed computing system may be so configured such that one disjointed subsystem cannot perform one or more specific operations on its corresponding data component of a BEIU unless enabled by another disjointed subsystem operating on another data component of that BEIU.

For much of the following description, it will be convenient to discuss embodiments of the present invention in which the disjointed computing system includes two disjointed subsystems operating on two BEIU data components. However, it should be understood that a disjointed computing system with more than two disjointed subsystems, and more that two BEIU data components, fall within the scope of the present invention.

In embodiments of the present invention, a disjointed subsystem may be referred to as a “protected subsystem” operating on a data word component of a BEIU. Another disjointed subsystem may be referred to as a “supervisor subsystem” operating on a stamp component of a BEIU. The content of the word component and stamp component together may be referred to as extended information. The protected subsystem is a computing system that operates on the data word component of a BEIU performs much as a standard computing system operating on a data word. We use the term “data word” to refer to a number of bits that represent a unit of data. The protected subsystem may be programmed to perform standard operations on the data word component. Operations may include transferring operations, in which data is loaded, copied, or moved from one location to another, without regard to the value of the data. Transferring operations may include such operations as storing data to memory, retrieving data from memory, inputting data, and outputting data. Operations may also include processing operations in which the value of the data is processed or manipulated, i.e. altered or utilized. Processing operations include such manipulations as arithmetic operations and logic operations. The protected subsystem may include, for example, standard computer devices such as processing units, memory units, and input and output devices.

The protected subsystem may include devices configured for BEIU data. When so configured, when the protected subsystem performs a transfer operation on a BEIU, both components of the BEIU are transferred. However, the protected subsystem may not alter or utilize the stamp component. Thus, arithmetic or other operation that is performed on the word component of a BEIU by the protected subsystem, and that alters or utilizes the value of the word component or that creates a new BEIU, does not alter the value of the stamp component of the BEIU. An important aspect of embodiments of the present invention is that the inability of the protected subsystem to modify the stamp component of the BEIU is secured at the hardware structure level of the disjointed computing system.

A BEIU of a disjointed computing system with more than two subsystems may be composed of multiple word components and multiple stamp components that correspond to multiple protected and supervisor disjointed subsystems, respectively.

A calculation involving the stamp component of a BEIU may be performed only by a stamp processing system, which may be referred to as a supervisor subsystem. When a complete BEIU is copied or is operated upon, for example, when storing, loading, or carrying out another operation involving memory, the word and stamp components are operated upon by the protected subsystem without altering the stamp component. The supervisor subsystem may be configured so as to operate on or read a BEIU only when the BEIU meets predefined criteria. For example, the supervisor subsystem may only relate to a BEIU that is stored on a predefined storage device, that resides on a predefined volatile or non-volatile memory device, or that occupies a predefined register of the protected subsystem.

The stamp processing, or supervisor, subsystem may include electronic devices that incorporate a standard or modified digital computing system, an analog system, or a combined analog-digital system. The supervisor and protected subsystems may be operationally coupled to each other by asymmetric relations. For example, the supervisor subsystem may enable or disable certain operations of the protected subsystem. The supervisor subsystem may thus be described as performing a “veto” operation over operations of the protected subsystem. The supervisor subsystem may use the information in the stamp component of the BEIU in accordance with programmed algorithms and policies to determine whether to enable or disable an operation of the protected subsystem. The supervisor subsystem executes an operation to enable or disable a protected subsystem operation by means of a dedicated hardware component. The dedicated hardware component may be considered part of the supervisor subsystem, part of the protected subsystem, may be a separate hardware entity, or may be a combination of two or more of the above. The enable or disable decision, however, is made solely through the logic of the supervisor subsystem. The decision does not depend on the logic of the protected subsystem, and cannot be altered or affected by the protected subsystem.

The value of a stamp component of a BEIU may be set, read, written, or altered by an appropriately configured device associated with the supervisor subsystem. The device cannot alter the value of the data word component, and the device cannot be accessed by the protected subsystem. In addition, the supervisor subsystem may perform logical or arithmetic operations on the stamp component. On the other hand, the value of the stamp component is not available to any component of the protected subsystem, or to the protected subsystem as a whole. The protected subsystem may not, therefore, perform arithmetic or logic operations on the stamp component.

In some embodiments of the present invention, the supervisor subsystem may monitor operations in the protected subsystem. For example, the supervisor subsystem may be configured to detect when the protected subsystem performs an operation on the word component of a BEIU. The supervisor subsystem may retain the value of the stamp component of the BEIU, or may change it in accordance with programmed instructions. The supervisor subsystem may also be configured to detect when the protected subsystem performs an operation, such as an arithmetic operation, that alters the value of the word component of a BEIU, or that results in a new BEIU. In this case, the supervisor subsystem may assign a value to the stamp component of the new BEIU based on programmed instructions. Alternatively, the supervisor subsystem may also be configured to monitor the protected subsystem in such a manner as to detect the nature of an operation, such as the nature of an arithmetic operation, performed by the protected subsystem on the word component of a BEIU. The supervisor subsystem may assign a value to the stamp component of an altered or created BEIU based on programmed instructions and on the nature of an operation performed by the protected subsystem.

The value of the stamp component of a BEIU may be assigned such as to indicate information regarding the BEIU components or the BEIU as a whole. Such indicated information may include an indication of the source of the information in a component of the BEIU, or of the extended information. Such source information may include an address or identity of, for example, a port connection, peripheral device, or any other device or component of the protected subsystem. The value of the stamp component may be assigned by the supervisor subsystem on the basis of a value generated by an external analog or digital device. In the case that the value of the stamp component is missing, undefined, or unrecognized, the supervisor subsystem may assign a stamp value in accordance with predefined rules. Such assignment of a stamp component value may enable a disjointed computing system to accept data from an external computing system, or from a data source that is based on ordinary non-BEIU data words. Assignment of a stamp component value converts the data to BEIU data for use by the disjointed computing system, in accordance with predefined rules.

The supervisor subsystem may set the value of a stamp component of a BEIU when operating in a setting mode. The value of the stamp component may be set according to an algorithm, or may be set by a human operator. When the supervisor subsystem is in the setting mode, the extent of coupling between the subsystems may be expanded. Such expanded coupling may, for example, enable setting the value of the stamp component of a BEIU on the basis of the value of the data word component or on the basis of any other information available to some or all of the subsystems.

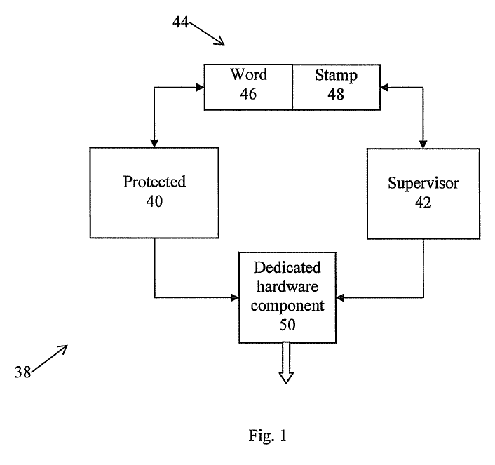

FIG. 1 is a schematic diagram of a disjointed computing system operating on an extended information element, in accordance with embodiments of the present invention. Protected subsystem 40 of disjointed computing system 38 may operate on or manipulate word component 46 of BEIU 44. Protected subsystem 40 may perform a transfer operation on BEIU 44, but may not manipulate stamp component 48. Supervisor subsystem 42 of disjointed computing system 38 may operate or manipulate stamp component 48 of BEIU 44. However, supervisor subsystem 42 may not manipulate word component 46. Operation of dedicated hardware component 50 depends on input from both protected subsystem 40 and supervisor subsystem 42. For example, dedicated hardware component 50 may include a write head that is capable of writing the value of word component 46, provided by protected subsystem 40. However, dedicated hardware component 50 may be configured such that it may only write a value when authorized to do so by an authorization signal provided by supervisor subsystem 42. Supervisor subsystem 42 determines whether or not to provide an authorization signal on the basis of the value of stamp component 48. Thus, dedicated hardware component 50 provides functional coupling between the disjointed subsystems of disjointed computing system 38.

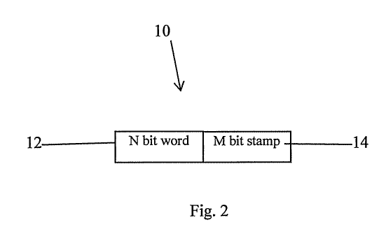

Implementation of disjointed computing system in accordance with embodiments of the present invention may be adapted to utilize hardware properties of system devices. For example, consider a computing system utilizing a computing device with memory device architecture configured such that a memory address occupies at least N+M bits. A disjointed computing system may be configured such that each memory address is capable of holding a BEIU with at least two components. FIG. 2 is a schematic illustration of a BEIU with a word component and a stamp component, in accordance with embodiments of the present invention. In this case, a disjointed computing system may be configured with disjointed subsystems that access the same memory device. A BEIU 10 of the computing system may occupy a memory address. One subsystem may be configured to access and operate on an N-bit data word 12 of BEIU 10. A second subsystem may be configured to access and operate on an M-bit stamp 14 of BEIU 10. The subsystem configured to access N-bit word 12 may operate as a protected subsystem. The subsystem that is configured to access M-bit stamp 14 may operate as a supervisor subsystem.

For example, in some standard computing systems, a 32-bit application is executed on a computer with 64-bit memory architecture. That is, a single data word of the standard computing system occupies 32 bits of a 64-bit memory address. This standard computing system may serve as a protected subsystem of a disjointed computing system. 32 bits at the memory address are inaccessible by the protected subsystem. A second application may be executed by a second disjointed subsystem, configured to access and operate on some or all of the remaining 32 bits at the memory address that are inaccessible to the protected subsystem. The second application is configured such that it cannot access any of the 32 bits that are accessible by the protected subsystem. The second application may serve as a supervisor subsystem of the disjointed computing system. Thus, between 1 and 32 bits at the memory address may be accessed and operated on as a stamp component of a BEIU. Should the stamp component of the BEIU occupy fewer than 32 bits, one or more additional disjointed subsystems may be configured to access and operate on all or part of the remaining inaccessible bits at the memory address. In a similar fashion, if the application is configured for an 8-bit word, the BEIU may occupy as few as 9 bits (8-bit word and 1-bit stamp). On the other hand, should the computer be configured with 128-bit architecture, the BEIU may occupy as many as 128 bits.

Furthermore, the information of a stamp component of a BEIU in a disjointed subsystem of a disjointed computing system may be based on any other measurable property, including, but not limited to, electromagnetic, optical, mechanical, physiochemical, biometric, or biological properties. A disjointed subsystem operating on such a stamp component would include appropriate sensors for detecting the appropriate properties. Such a disjointed subsystem may also include appropriate devices for generating such properties, where applicable.

A stamp component of a BEIU may hold various types of information and content. For example, the content of stamp component of a BEIU may indicate one or more properties associated with another component of the BEIU, such as a data word. Such properties may include, for example, a trust level for determining access to data in another component of the BEIU, the source of the data in the other component, marking the data as permanent or modifiable, status, electronic watermark, identification of a user, permission to perform an operation on the other component, and other properties.

Disjointed subsystems of a disjointed computing system may be operationally coupled by means of appropriate operations. For example, a protected subsystem may be required to access data in a word component of a BEIU by means of an appropriate device. The protected subsystem may issue an instruction to the device to read, write, modify, erase, or overwrite data. However, the device may be configured such that the instruction cannot be executed without being enabled by an appropriate signal received from at least one additional disjointed subsystem, such as a supervisor subsystem.

For example, the operation of writing data to a memory device may be configured to write a data word component of a BEIU only when receiving both an instruction to write the word from a protected subsystem and an enabling instruction from a supervisor subsystem. Whether or not the supervisor subsystem issues an enabling instruction may depend on the value of the stamp component of the BEIU. A disjointed computing system configured in this manner may avoid an undesirable loss of data through overwriting, whether due to error or to malicious intent, and whether due to causes that are either internal or external to the system.

A subsystem of a disjointed computing system may be required to set the value of a stamp component of a BEIU on the basis of information that is ordinarily available only to another disjointed subsystem. Such restricted information may be communicated to the subsystem by means of an external trusted entity, such as a secure out-of-band communications link. Such a link does not, however, enable direct access by one subsystem to the information available to another subsystem. Alternatively, an authorized user may switch from one subsystem to another in a secure manner, such as by inserting and turning a key, entering a code, or other means. In this case, the user's knowledge of both subsystems, the coupling between them, and the relations between the BEIU components and corresponding subsystems, serves as the method of transferring information from one subsystem to the other. Alternatively, a subsystem may be configured to automatically assign a value to the stamp component of any BEIU that is located at a predefined memory address, transferred via a predefined communications or data channel, or in accordance with any other predefined criteria.

In accordance with embodiments of the present invention, a disjointed computing system may be configured to safely communicate with non-secure environments, such as the Internet. For example, during communication with a non-secure environment, all incoming data and programs may be marked with appropriate stamps that indicate security and accessibility restrictions. Furthermore, since each disjointed subsystem contains no information regarding other subsystems, the disjointed computing system is, therefore, considerably resistant to deliberate attempts to breach system security.

Embodiments of the present invention may be applied to the creation of a secure transaction record (STR). In this application, disjointed computing architecture is applied to create a reliable and secure transaction audit trail. The transaction audit trail is resistant to attempts, whether via a network or via a local user interface, to compromise the integrity or confidentiality of protected data. Such an STR application may be beneficial when applied in a transaction-driven environment, such as a financial institution or stock market, where full confidence in transaction audit trails is critical.

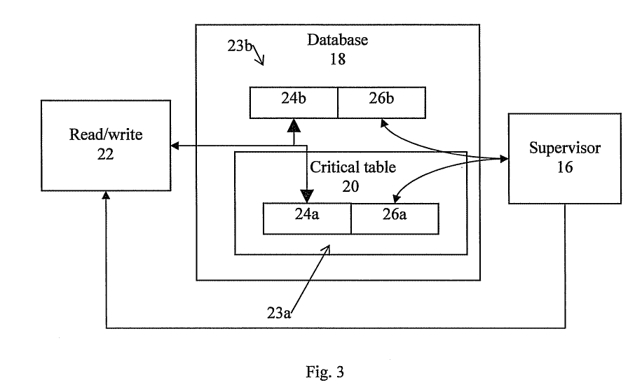

FIG. 3 is a block diagram of a secure transaction record system in accordance with embodiments of the present invention. In an STR application, a protected subsystem of a disjointed computing system includes database 18 located on one or more data servers. Data is written to or read from database 18 by means of read/write drive 22. A second subsystem, supervisor subsystem 16, operates in a disjointed manner from the protected subsystem. Data in the database is organized in database tables. One or more database tables, typically those storing transaction records, may be defined as critical tables, such as critical table 20. Supervisor subsystem 16 attaches to a data word 24a of database 18 a stamp 26a that marks data word 24a as protected. Word 24a and stamp 26a together form protected BEIU 23a. Supervisor subsystem 16 is so configured that once data word 24a is marked as protected by stamp 26a, stamp 26a cannot be modified. A data word 24b of database 18 that is not part of critical table 20 may be stamped with a stamp 26b that indicates that data word 24b is not protected. Word 24b and stamp 26b together form unprotected BEIU 23b. Alternatively, data word 24b may remain unstamped, or the value of stamp 26b may be a predetermined blank or null value.

Operation of read/write drive 22 may be contingent upon an enabling signal provided by supervisor subsystem 16. For example, supervisor subsystem 16 may be integrated with low-level electronic access to read/write drive 22 via which the enabling signal may be provided. For example, a wire may be added to a Serial Advanced Technology Attachment (SATA) interface of read/write drive 22. In order to provide additional protection, the enabling signal may be encrypted.

Supervisor subsystem 16 may be programmed or configured with policies that protect data in critical table 20 from unwanted access. For example, supervisor subsystem 16 may be configured so as to emulate the operation of a write-once-read-many (WORM) drive. However, emulation of a WORM drive may provide a more flexible and a less expensive solution than providing an actual WORM drive. In this configuration, a data word 24a of critical table 20 is marked as protected by means of stamp 26a when it is first written, the value of stamp 26a defining a read-only word component. Supervisor subsystem 16 is configured so as not to enable overwriting a data word 24a that is marked as protected by means of a stamp 26a.

In another example, supervisor subsystem 16 may be configured to prevent unauthorized reading of a data word whose associated stamp indicates the data as being protected data of critical table 20. In this configuration, supervisor subsystem 16 allows writing only at an unoccupied data address in critical table 20. Reading of protected data may be allowed only under predefined circumstances. For example, reading of protected data may be enabled only at predefined intervals, as defined by a clock function associated with supervisor subsystem 16. The predefined intervals, for example, may correspond to scheduled times for data backup or archiving. As further protection, reading of protected data may be limited to a predefined entity. A read command issued by the predefined entity may be recognized by means a stamp component of a command BEIU, or via encryption.

Embodiments of the present invention may be applied to continuous distributed data management (CDDM). CDDM facilitates the creation of a distributed trusted environment on an insecure network, such as the Internet. Such a trusted environment may enable continuous data protection (CDP), continuous data backup (CDB), or both. The trusted environment includes a network of trusted computing devices that incorporate the CDDM technology.

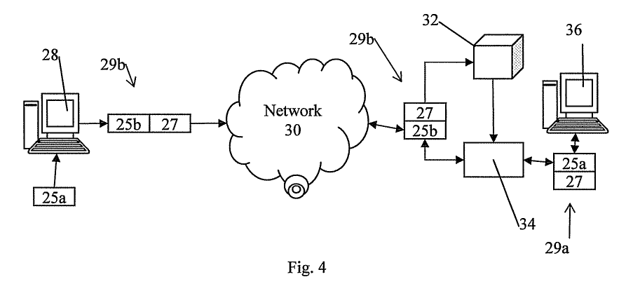

FIG. 4 is a block diagram of continuous distributed data management in accordance with embodiments of the present invention. Under CDDM, data, such as data word 25a accessible by a first subsystem of a disjointed computing system, enters the subsystem only via a centralized data center or trusted source 28. Trusted source 28 stamps data word 25a with stamp 27 that is accessible to a second subsystem. The content of stamp 27 associates data word 25a with a predefined protection profile. In addition, data word 25a may be encrypted by trusted source 28. The encryption key is determined by the content of stamp 27. Encrypted data word 25b and associated stamp 27 are made available to network 30 as encrypted BEIU 29b. Each trusted computing device 36 operates as part of the first subsystem. Each trusted computing device 36 communicates with network 30 via a network card 34. Network card 34 may incorporate encryption and decryption capability. In addition, each trusted computing device 36 is associated with a CDDM supervisor 32 that operates as part of the second subsystem. Network card 34 may receive an encrypted BEIU 29b from network 30. CDDM supervisor 32 reads stamp 27 of encrypted BEIU 29b and may provide an encryption key, or a value for determining an encryption key, to network card 34. Using the encryption key, network card 34 decrypts encrypted data word 25b, creating decrypted data word 25a and decrypted BEIU 29a. Network card 34 sends decrypted data word 25a to trusted computing device 36. Trusted computing device 36 may then access or operate on data word 25a. When trusted computing device 36 sends data via network 30, the process is reversed: Trusted computing device 36 sends data word 25a to network card 34. CDDM supervisor 32 reads associated stamp 27 from network card 34 and provides an encryption key, or a value for determining an encryption key, to network card 34. Using the encryption key, network card 34 encrypts data word 25a, creating encrypted data word 25b. Network card 34 then sends encrypted BEIU 29b containing encrypted data word 25b to network 30.

A computing device that is not part of the trusted CDDM environment cannot access data from the network. Such a computing device would lack a CDDM supervisor and would not be able to access the stamp associated with the data. Since the encryption key depends on the value of the stamp associated with the data, a device that is not part of the trusted CDDM environment would not be able to decrypt the data. Should data be introduced to a subsystem in any manner other than through trusted source 28, the data would not be stamped. Data that is unstamped would not become part of the trusted environment, and would be rejected by network card 34.

CDDM supervisor 32 interacts directly with network card 34, before the data is processed by any of the various Internet communications protocols (i.e. prior to entering the “Internet protocol stack”) on trusted computing device 36. Thus, security of the data would be maintained even if the security of trusted computing device 36 is itself compromised.

CDDM provides a way to implement a trusted computing environment on a distributed network without having control of the network infrastructure. It thus extends the single-device/controlled-environment trusted computing model to any set of distributed devices. CDDM supports scenarios such as a secure laptop in a highly insecure environment communicating continuously with a remote trusted network without endangering critical data on the laptop or on the remote secure network. Such an implementation could be very useful under certain circumstances, such as in military or intelligence applications.

Thus, embodiments of the present invention provide comprehensive security for computing devices.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for processing an extended information element, the extended information element composed of a word component and a stamp component, by a computing system that can transfer the extended information element but cannot manipulate the stamp component of the extended information element, the method comprising:
providing a stamp processing system for manipulating the stamp component;
processing a value of the stamp component by the stamp processing system; and
controlling an operation on the word component based on the value of the stamp component.

2. The method as claimed in claim 1, further comprising generating the stamp component.

3. The method as claimed in claim 1, further comprising assigning the value to the stamp component.

4. The method as claimed in claim 1, wherein the value of the stamp indicates a characteristic of the word component.

5. The method as claimed in claim 4, wherein the characteristic of the word is selected from the group of characteristics consisting of: type, source of the word component, connection port through which the word component was received, time, security profile, access rights, read-only, hidden and human defined value.

6. The method of claim 1, wherein the operation is performed by the computing system.

7. The method as claimed in claim 1, wherein the operation on the word component comprises enabling or disabling the processing of the word component.

8. The method as claimed in claim 1, wherein the operation on the word component comprises encryption or decryption.

9. The method as claimed in claim 1, wherein the word component is a 32-bit word and the stamp component includes at least one additional bit.

10. The method as claimed in claim 1, wherein the extended information element is a selected from a group of information elements ranging from 9 to 128 bit information elements.

11. The method as claimed in claim 1, wherein the step of controlling the operation on the word component based on the value of the stamp component is executed by the stamp processing system.

12. A system for processing an extended information element, the extended information element composed of a word component and a stamp component, by a computing system that can transfer the extended information element but cannot manipulate the stamp component of the extended information element, the system comprising:
a stamp processing system for manipulating the stamp component, adapted to process a value of the stamp component for controlling an operation on the word component based on the value of the stamp component.

13. The system as claimed in claim 12, wherein the stamp processing system is adapted to generate the stamp component.

14. The system as claimed in claim 12, wherein the stamp processing system is adapted to assign the value to the stamp component.

15. The system as claimed in claim 12, wherein the value of the stamp indicates a characteristic of the word component.

16. The system as claimed in claim 15, wherein the characteristic of the word is selected from the group of characteristics consisting of: type, source of the word component, connection port through which the word component was received, time, security profile, access rights, read-only, hidden and human defined value.

17. The system as claimed in claim 12, wherein the operation is performed by the computing system.

18. The system as claimed in claim 12, wherein the operation on the word component comprises enabling or disabling the processing of the word component.

19. The system as claimed in claim 12, wherein the operation on the word component comprises encryption or decryption.

20. The system as claimed in claim 12, wherein the word component is a 32-bit word and the stamp component includes at least one additional bit.

21. The system as claimed in claim 12, wherein the extended information element is a selected from a group of information elements ranging from 9 to 128 bit information elements.

22. The system as claimed in claim 12, wherein the stamp processing system is adapted to control the operation on the word component based on the value of the stamp component.

23. The system as claimed in claim 12, wherein the stamp processing system and the computing system are integrated.
